(19) United States
(12) Patent Application Publication
(10) Pub. No.: US 2006/0233620 A1
(43) Pub. Date: Oct. 19, 2006

(54) Fixturing device for drilling workpieces

(76) Inventor: Richard Herrick, Miramar, FL (US)

Correspondence Address: LERNER GREENBERG STEMER LLP, P O BOX 2480, HOLLYWOOD, FL, 33022-2480, US

(21) Appl. No.: 11/105,273

(22) Filed: Apr. 13, 2005

(51) Int. Cl. B23B 47/28

(52) U.S. Cl. 408/115 R

(57) ABSTRACT

A fixturing device for holding a workpiece with a longitudinal axis is disclosed. The fixturing device includes a first v-block with holding surfaces that intersect each other at an intersection and form a v-shape. The first v-block has a hole formed therein with a center axis that is substantially perpendicular to the longitudinal axis of the workpiece and intersects the intersection of the holding surfaces. A clamping arm mounted to the first v-block for clamping the workpiece in the first v-block. A second v-block that is similar to the first v-block is also provided. A clamping arm is mounted to the second v-block for clamping the workpiece to the second v-block. A cross-member adjustably attaches the first v-block to the second v-block. At least one drill bushing is removably disposed in one of the hole in the first v-block and the hole in the second v-block.

### BACKGROUND OF THE INVENTION

1. Field of the Invention

The invention relates to an apparatus for fixturing workpieces that are to be drilled, more specifically, to a drilling fixture that can be used for the precision drilling of holes in workpieces of different shapes and sizes.

2. Description of the Related Art

It is prior-art practice, for example, in the case of drilling holes in workpieces to use a hand drill with a center punch for marking the location to be drilled. This practice has the disadvantage that the drill bit can walk on the workpiece thereby causing a marring of the workpiece or causing the hole to be drilled at an improper location. Also, there is the disadvantage that since the drill bit is not oriented or guided with respect to the workpiece the drilled hole will not be drilled at the proper angle with respect to the axis, plane, surface, or diameter of the workpiece.

In order to deal with these problems it is known from the prior art to use a drill press and to set the workpiece up with clamps and fixtures. This solution has the disadvantages that it is quite expensive to own a drill press and the space required for a drill press can be quite large. Furthermore, it is very time consuming to set up the workpiece for drilling holes, especially for a part, which requires multiple holes drilled at different center distances along its length. A further disadvantage is that there is a limitation to the length of a workpiece which may have a hole drilled along its longitudinal axis (the length of the workpiece is limited by the working height of the drill press).

Accordingly, prior art drilling devices have the disadvantages that they do not provide a satisfactory solution for quickly setting up and accurately drilling a hole in the workpiece by securing the work piece for facilitating any hole placement (i.e., along the longitudinal axis, plane, or diameter of the workpiece, perpendicular to the longitudinal axis of the workpiece, or making multiple holes at any given center distance).

### SUMMARY OF THE INVENTION

It is accordingly an object of the invention to provide a drilling fixture which overcomes the above-mentioned disadvantages of the heretofore-known devices of this general type and which provides a drilling fixture that is accurate, easily manufactured, easy to maintain, quick and simply to use, has a great deal of versatility, and is reliable.

The present invention has the advantages that it is not restricted to just two holes at any center distance, it can be a multitude of hole locations and center distances. It securely clamps or locates over a specific hole location and because of its construction, it will not allow a drill bit to slip, mar, misalign or scratch plated or painted surfaces. This is especially important on painted or other finished workpieces. The present invention has the capability of drilling multiple work pieces exactly alike.

The simplicity of the present invention allows anyone with various skill levels to successfully use the drilling fixture. It is very lightweight and extremely portable.

The present invention is applicable in the following fields of use: pipe fitting and plumbing instances, fabricating shops (steel, wood, etc.); welding shops (positioning weldments etc.); in medical fields (accuracy in bone repair and reinforcing plates to be located, drilled and screwed); and irrigation (adding sprinklers to existing lines by accurately drilling and tapping for a specific nipple size).

The present invention is convenient to use for the following applications: for locating holes to be drilled in round bars and dowel tubes; accurate drilling of bar stock (round, square, hex or rectangular) perpendicularly or at other angles; drilling, with a high level of accuracy, a hole in the end of any length work piece (dowels etc.); drilling out a broken screw in an existing hole; and accurately drilling a hole through the corner of a square bar tube or angle iron.

The present invention also achieves subsequent hole locations at perpendicular or angular locations intersecting with or being offset to previously drilled holes (such as is used in building of furniture or table legs).

The present invention will adapt to any shape work piece (i.e. square, rectangular, round, hex or elliptical). It also has a very unique feature that allows a user to drill any size through hole or blind hole in a circular helical pattern of infinite center distances and angular positions which could conceivably produce a work piece that would have a spiraling pattern for whatever length desired (such as a barber pole pattern).

With the foregoing and other objects in view there is provided, in accordance with the invention a fixturing device for holding a workpiece having a longitudinal axis. The device has a first v-block with holding surfaces that intersect each other at an intersection and form a v-shape. The first v-block has a hole formed therein with a center axis that is substantially perpendicular to the longitudinal axis of the workpiece and intersects the intersection of the holding surfaces. A clamping arm is mounted to the first v-block for clamping the workpiece in the first v-block. A second v-block has holding surfaces that intersect each other at an intersection and form a v-shape. The second v-block has a hole formed therein with a center axis that is substantially perpendicular to the longitudinal axis of the workpiece and intersects the intersection of the holding surfaces of the second v-block. A clamping arm is mounted to the second v-block for clamping the workpiece to the second v-block. A cross-member adjustably attaches the first v-block to the second v-block. At least one drill bushing is removably disposed in one of the hole in the first v-block and the hole in the second v-block.

In accordance with another feature of the invention, a locating arm is mounted to the first v-block for positioning the workpiece in the direction of its longitudinal axis. A channel is formed in the first v-block for accommodating the locating arm.

In accordance with a further feature of the invention, the first and second v-blocks each have a respective groove formed therein for accommodating the cross-member. The grooves are substantially parallel to the longitudinal axis of the workpiece.

In accordance with an added feature of the invention, the locating arm is L-shaped, has a hole formed therein for receiving one of the at least one drill bushings. A slot is formed in the locating arm for adjusting a position of the locating arm in the channel.

In accordance with an additional feature of the invention a 90° radial locating arm has a hole formed therein. The 90° radial locating arm is removably and adjustably mounted to one of the cross member, the first v-block, and the second v-block. One of the at least one drill bushing is removably disposed in the hole of the 90° radial locating arm. A locating pin is insertable into the one of the at least one drill bushings and into a hole formed in the workpiece for radially locating the workpiece.

In accordance with yet another feature of the invention, a tube is removably disposed in the hole of the locating arm and a stop bar is adjustably mounted to the tube for positioning the workpiece in a direction along the longitudinal axis of the workpiece.

In accordance with yet a further feature of the invention, a 45° radial locating arm has a hole formed therein, the 45° radial locating arm is removably and adjustably mounted to one of the cross member, the first v-block, and the second v-block. One of the at least one drill bushings is removably disposed in the hole of the 45° radial locating arm. The locating pin is insertable into the one of the at least one drill bushings and into a hole in the workpiece for radially locating the workpiece.

In accordance with yet an added feature of the invention, the tube includes graduations for positioning the stop bar and the cross member includes graduations for positioning the second v-block with respect to the first v-block.

In accordance with yet an additional feature of the invention, a further drill bushing has a chamfer. A chamfer is formed in the hole of the L-shaped bracket aligning with the chamfer of the drill bushing when the further drill bushing is inserted into the L-shaped bracket. The chamfers co-axially align the hole of the L-shaped bracket with the workpiece.

In accordance with still another feature of the invention, one of the at least one drill bushings is insertable into the hole in the L-shaped bracket for drilling a hole along the longitudinal axis of the workpiece.

With the objects of the invention in view, there is also provided in accordance with the invention a fixturing device for holding a workpiece with a longitudinal axis. The device includes a v-block with holding surfaces that intersect each other at an intersection and form a v-shape. The v-block has a hole formed therein with a center axis that is substantially perpendicular to the longitudinal axis of the workpiece and intersects the intersection of the holding surfaces. A clamping arm is mounted to the first v-block for clamping the workpiece in the v-block. At least one drill bushing is removably disposed in the hole of the v-block.

In accordance with still a further feature of the invention, a channel is formed in the v-block. A locating arm for positioning the workpiece along a direction of its longitudinal axis is mounted in the channel. The locating arm is L-shaped, has a hole formed therein, and a slot formed therein for adjusting a position of the locating arm in the channel.

In accordance with a further feature of the invention, a tube is removably disposed in the hole of the locating arm and a stop bar is adjustably mounted to the tube for positioning the workpiece in a direction along the longitudinal axis of the workpiece.

In accordance with an added feature of the invention, a 90° radial locating arm has a hole formed therein, the 90° radial locating arm is removably and adjustably mounted to the v-block. One of the at least one drill bushings is removably disposed in the hole of the 90° radial locating arm. A locating pin is insertable into one of the at least one drill bushings and into a hole in the workpiece for radially locating the workpiece.

In accordance with an additional feature of the invention a 45° radial locating arm has a hole formed therein, the 45° radial locating arm is removably and adjustable mounted the v-block. One of the at least one drill bushings is removably disposed in the hole of the 45° radial locating arm. The locating pin is insertable into the at least one drill bushing and into a hole in the workpiece for radially locating the workpiece.

With the objects of the invention in view, there is also provided a fixturing device for holding a workpiece having a longitudinal axis. The device has a first v-block with holding surfaces that intersect each other at an intersection and form a v-shape. The first v-block has a hole formed therein with a center axis that is substantially perpendicular to the longitudinal axis of the workpiece and intersects the intersection of the holding surfaces. A clamping arm is mounted to the first v-block for clamping the workpiece in the first v-block. A second v-block has holding surfaces that intersect each other at an intersection and form a v-shape. The second v-block has a hole formed therein with a center axis that is substantially perpendicular to the longitudinal axis of the workpiece and intersects the intersection of the holding surfaces of the second v-block. A clamping arm is mounted to the second v-block for clamping the workpiece to the second v-block. At least one drill bushing is removably disposed in one of the hole in the first v-block and the hole in the second v-block.

Other features which are considered as characteristic for the invention are set forth in the appended claims.

Although the invention is illustrated and described herein as embodied as a fixturing device for drilling workpieces, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of the drilling fixture according to the invention as seen from the workpiece holding side with a round workpiece mounted in the drilling fixture;

FIG. 2 is a perspective view of the drilling fixture according to FIG. 1 as seen from the workpiece holding side with a square workpiece mounted in the drilling fixture;

FIG. 3 is an exploded view of the drilling fixture according to FIG. 1 as seen from the workpiece holding side;

FIG. 4 is a perspective view of the drilling fixture according to FIG. 1 as seen from the workpiece holding side with a square workpiece mounted in the drilling fixture with the v-blocks separated from the connecting bar; and

FIG. 5 is a partial perspective view of the drilling fixture according to FIG. 1 as seen from opposite the workpiece holding side showing a locating mechanism for axial drilling of the workpiece;

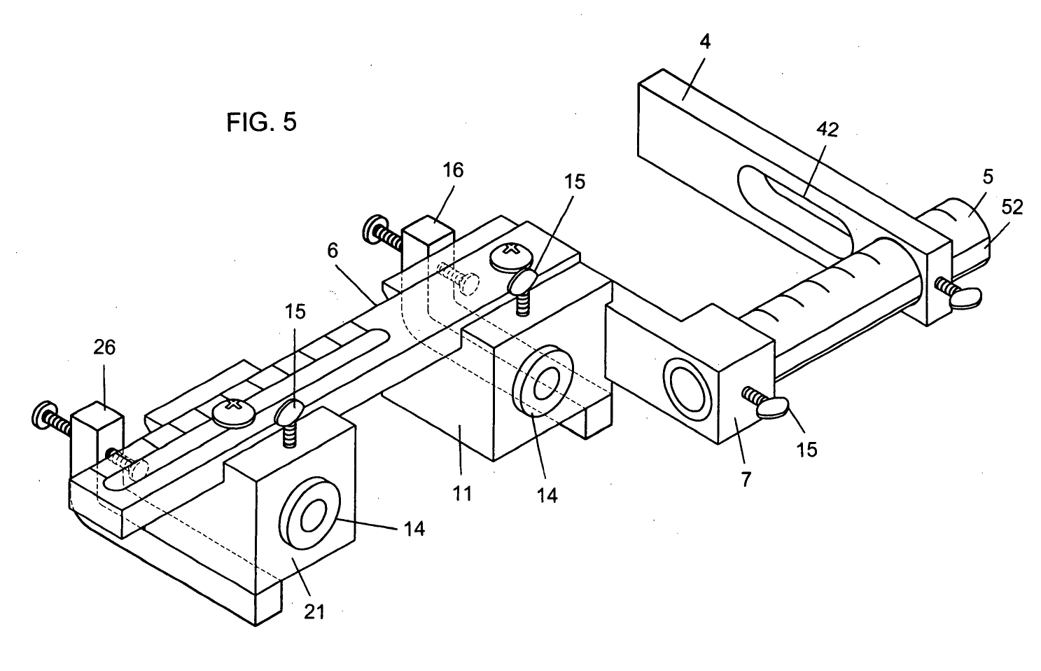

FIG. 6 is a partial perspective view of the drilling fixture according to FIG. 1 showing a conical locator for locating an L-shaped locating bar; and

FIG. 7 is a perspective view of the drilling fixture according to FIG. 1 as seen from the workpiece holding side, where the fixture is set up to drill a hole that is co-axial to the longitudinal axis of the workpiece.

### DESCRIPTION OF THE PREFERRED EMBODIMENTS

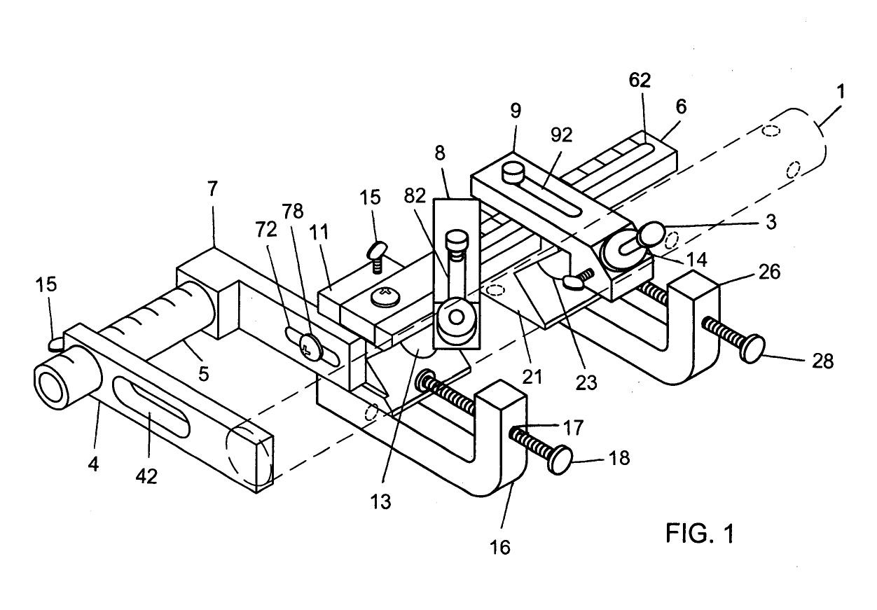

Referring now to the figures of the drawing in detail and first, particularly, to FIG. 1 thereof, there is seen a drilling fixture according to the invention. The drilling fixture allows for the accurate drilling of differently aligned holes in a workpiece.

The drilling fixture includes a first v-block 11 and a second v-block 21, which are attached to each other by a mounting cross-member bar 6. The v-blocks 11 and 21 each have respective holding or locating surfaces 114 and 124 that support the workpiece when it is being drilled. It is noted that while the angle between the holding surfaces 114 and 124 of the v-blocks 11 and 21 is illustrated as being 90° it is not necessary that the angle between the holding surfaces 114 and 124 of the v-blocks 11 and 21 be 90°. The angle can be adjusted for the types of workpieces to be handled by the drilling fixture. The holding surfaces 114 and 124 intersect each other and form a v-shape. Transverse axes of the v-blocks 11 and 21 bisect the v-shape of the v-block and are perpendicular to the longitudinal axis of the workpiece 1, while the longitudinal axis of the v-blocks is parallel to the longitudinal axis of the workpiece 1 being held.

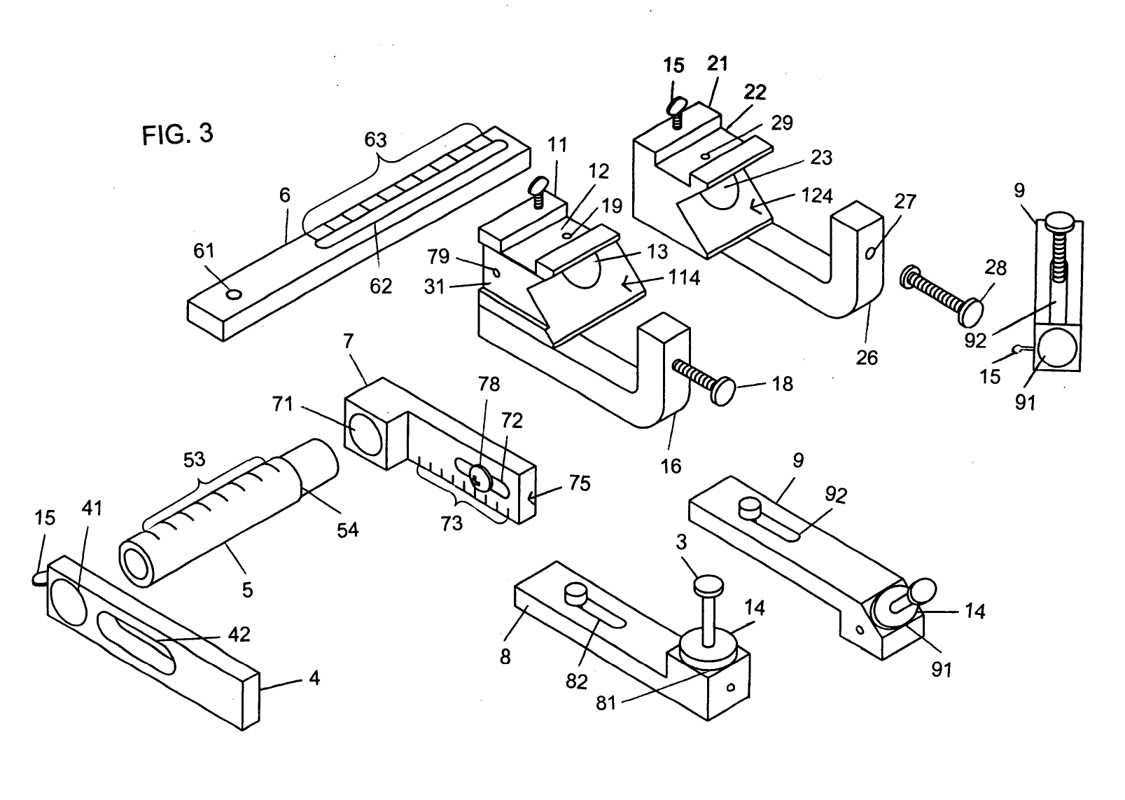

The first v-block 11 includes a hole 13 having an axis that is parallel to the transverse axis of the first v-block 11. The hole 13 (FIG. 3) accommodates drill bushings 14, which can be used to drill different sized holes (based on the size of the guide hole of the drill bushing), which are perpendicular to the longitudinal axis of the workpiece 1. The drill bushings 14 have a flat ground on the outer diameter, which prevents the drill bushing 14 from rotating by way of a set screw 15 provided in the v-block 11.

The first v-block 11 includes a first groove 12, which runs parallel to the longitudinal axis of the first v-block 11. The groove 12 is used for mounting a cross-member bar 6. The groove 12 includes a threaded hole 19 for attaching the first v-block 11 to the cross-member bar 6. The first v-block 11 includes a second groove 31, which runs parallel to the transverse axis of the first v-block 11. The second groove 31 accommodates an L-shaped locating bar 7, which will be discussed in further detail below. The L-shaped locating bar 7 is attached to the first v-block by a screw held in threaded hole 79.

The first v-block 11 includes an L-shaped clamping arm 16 that is attached thereto and is disposed parallel to the transverse axis of the first v-block 11. The clamping arm 16 includes a threaded hole 17, which, accommodates a screw holder 18 for holding/clamping the workpiece 1 in position for drilling of the workpiece 1. It is possible to hold the clamping arm 16 and thus the drilling fixture in a vise when drilling holes in the workpiece 1.

The second v-block 21 includes a hole 23 having an axis that is parallel to the transverse axis of the second v-block 21 and also the first v-block 11. The hole 23 (FIG. 3) accommodates drill bushings 14, which can be used to drill different sized holes (based on the size of the guide hole of the bushing), which are perpendicular to the longitudinal axis of the workpiece.

The second v-block 21 includes a groove 22, which runs parallel to the longitudinal axis of the second v-block 21 and also the longitudinal axis of the first v-block 11. The groove 22 (FIG. 3) is used for mounting the cross-member bar 6. The groove 22 includes a threaded hole 29 for attaching the second v-block 21 to the cross-member bar 6.

The second v-block 21 includes a L-shaped clamping arm 26 that is disposed parallel to the transverse axis of the second v-block 21. The clamping arm 26 includes a threaded hole 27, which accommodates a screw holder 28 for holding/clamping the workpiece 1 in position for drilling of the workpiece 1. It is possible to hold the clamping arm 26 in a vise when drilling holes in the workpiece 1.

A 90° radial locating arm 8 is provided for allowing alignment of the workpiece for the drilling of holes that are located 90° in relation to an existing hole. Alternatively, the 90° radial locating arm 8 can be used to drill a hole at 90° to an existing hole. The 90° radial locating arm 8 includes a hole 81 for accepting the drill bushings 14. A set screw 15 holds the selected drill bushing 14 in place. Locating pins 3 sized for matching the sizes of the guidance hole of the drill bushings 14 are used to locate the workpiece 1 for drilling a new hole at 90° (based on the presence of a previously drilled hole in the workpiece). The 90° radial locating arm 8 includes a slot 82 which fastens the 90° radial locating arm 8 to the cross-member bar 6 or to either one of the first and second v-blocks 11, 21. The slot 82 allows the 90° radial locating arm 8 to be positioned for different diameter/thickness workpieces 1.

A 45° radial locating arm 9 is provided for allowing alignment of the workpiece 1 for the drilling of holes that are located at 45° or 135° in relation to an existing hole. Alternatively, the 45° radial locating arm 9 can be used to drill a hole at 45° to an existing hole, i.e. in the corner of a square workpiece. The 45° radial locating arm 9 includes a hole 91 for accepting the drill bushings 14, which are held in place by a set screw 15. Locating pins 3 are used to locate the workpiece 1 in the same manner as is done with the 90° radial locating arm 8. The 45° radial locating arm 9 includes a slot 92, which fastens the 45° radial locating arm 9 to the cross-member bar 6 or to either one of the v-blocks 11 and 21. The slot 92 allows the 45° radial locating arm 9 to be positioned for different diameter/thickness workpieces 1. Furthermore, it is possible for the 45° locating arm to be mounted in the second groove 31 of the first v-block 11, in the same manner as the L-shaped locating bar 7. Using the 45° radial locating arm in the second groove 31 allows the drilling fixture to be able to drill holes for joinery (picture frames). Although the radial locating arms have been disclosed as being 45° and 90°, the radial locating arms can be made at any angle desired depending on the necessary application.

The cross-member bar 6 includes a hole 61 for mounting the first v-block 11 to the cross-member bar 6. The cross-member bar 6 also includes a slot 62 for mounting the second v-block 21. The cross-member bar 6 also has graduations 63 for setting an exact distance of the second v-block 21 in relation to the first v-block 11. As noted above, the slot 62 is also used for mounting the radial locating arms 8 and 9.

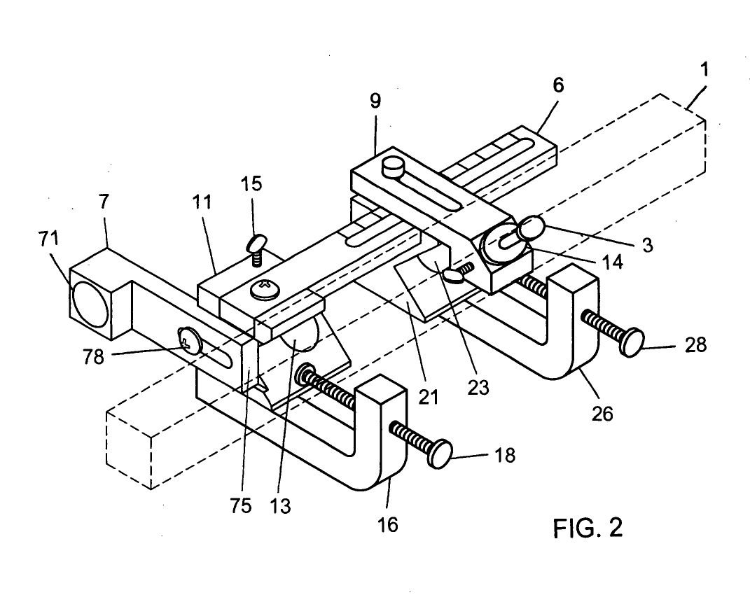

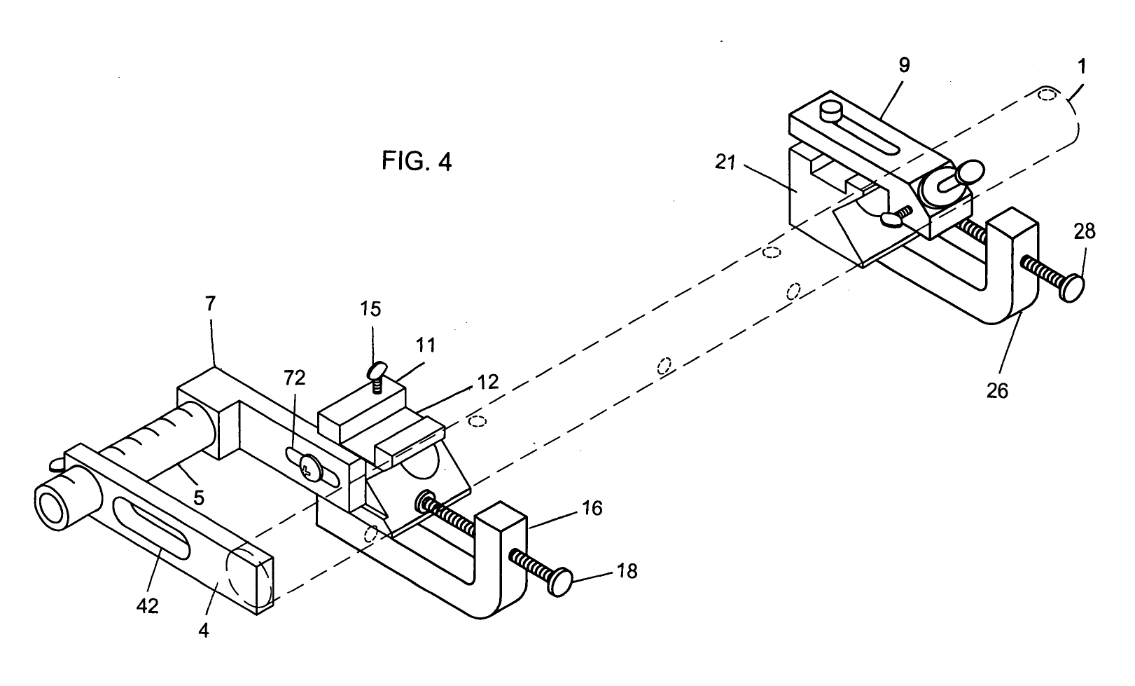

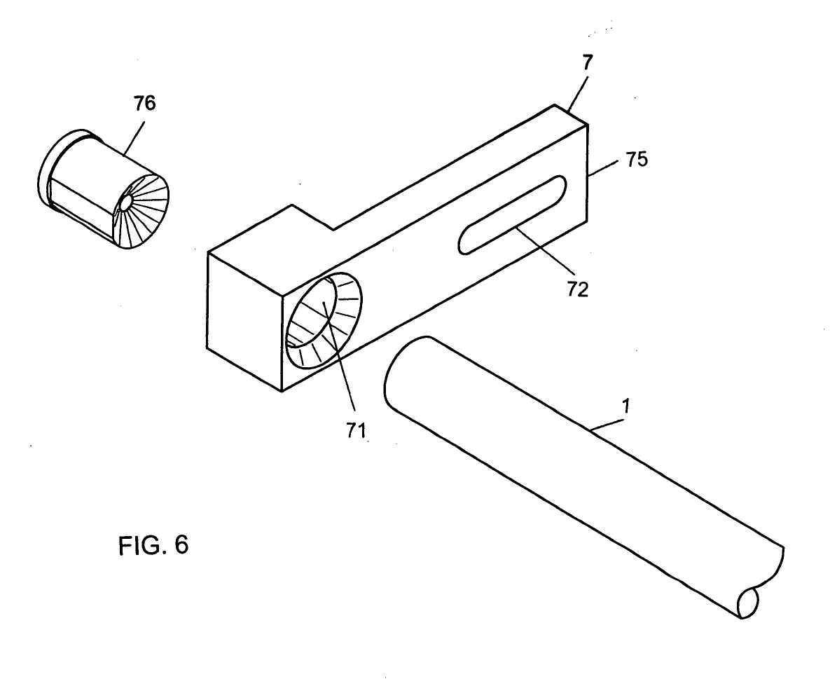

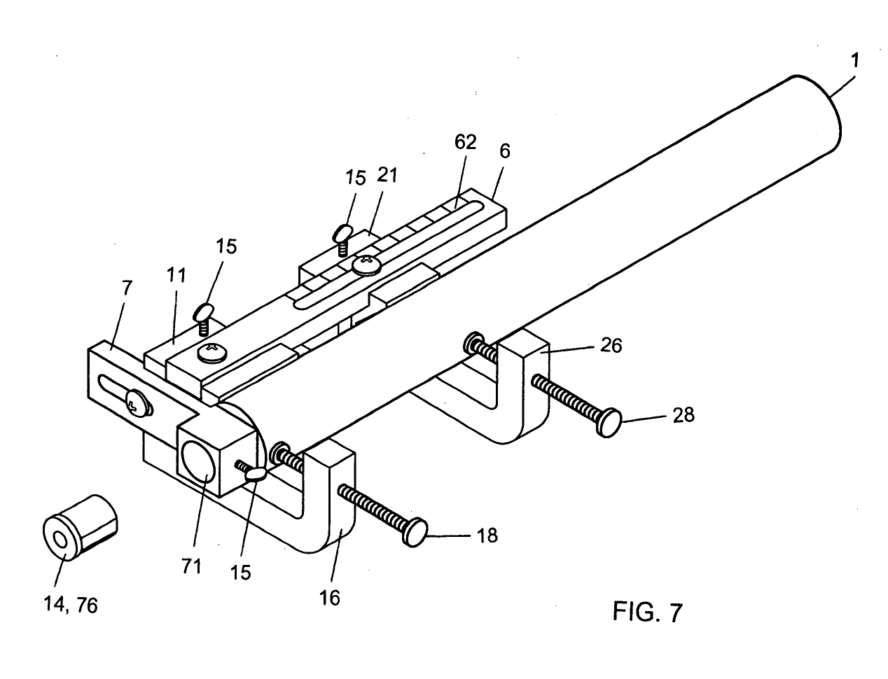

The L-shaped locating bar 7 mounted in the groove 31 by a screw 78 is rotatable 180° in the groove 31 (FIGS. 1 and 7). The L-shaped locating bar 7 includes a hole 71 which can accommodate the drill bushings 14 for drilling an axial hole in the end of a workpiece 1 (FIG. 7). The hole 71 in the L-shaped locating bar 7 can also accommodate a tube or rod 5 that is used together with a stop bar 4 for accurately positioning and locating the workpiece 1 in the longitudinal direction (FIG. 4). A set screw 15 firmly holds the drill bushings 14 or the tube 5 in place. The L-shaped locating bar 7 has a slot 72 for movably mounting the bar 7 in the groove 31. The L-shaped locating bar 7 has an end surface 75, which acts a stop for squarely positioning a square or rectangular workpiece 1 in the v-blocks 11 and 21 (FIG. 2). The L-shaped locating bar 7 also includes graduations 73 for the positioning of the bar 7 with respect to the first v-block 11. As shown in FIG. 6, a conical locator drill bushing 76 is inserted into the hole 71 of the locating bar 7. The conical locator bushing has a 45° chamfer at an end face thereof for seating the workpiece 1, which centers the hole 71 of the locating bar 7 with the longitudinal axis of the workpiece. The locating bar 7 includes a 45° chamfer at an end face thereof that aligns with the chamfer of the locator drill bushing 76. This allows the centering of a workpiece 1 which has a diameter greater than that of the conical locator drill bushing 76. The use of the conical locating drill bushing 76 with the bar 7, provides for drilling a hole that is co-axial with the longitudinal axis of the workpiece 1.

As is shown in FIG. 3, the rod 5 includes graduations 53 for positioning the stop bar 4, which is mounted on the rod 5 by a hole 41. The rod 5 has a shoulder 54 for locating the rod 5 in the hole 71 of the L-shaped locating bar 7. The rod 5 has a flat surface 52, for holding a set screw 15 mounted in the stop bar 4. The set screw allows the stop bar 4 to be positioned using the graduations 53 of the rod 5. The stop bar 4 has a slot 42, which allows access to the screw 78 which retains the L-shaped locating bar 7 so that the L-shaped locating bar 7 may be adjusted when the stop bar 4 is in place.

The operation of the device will be described with respect to the drawings and the above-provided description.

FIG. 1 shows the device set up for drilling radial holes on the outer perimeter of the workpiece 1. The v-blocks 11 and 21 are set in position on the cross-member bar 6. The stop bar 4 is positioned on the rod 5 to set the longitudinal position of the workpiece 1. Next, the workpiece 1 is clamped to the first and second v-blocks 11 and 21 by the clamping arms 16 and 26 and the screw holders 18 and 28. Once the workpiece 1 is in position, accurately positioned radial holes may be drilled in the workpiece 1 by guiding a drill bit through the drill bushings 14, which are mounted in the v-blocks 11 and 21. In order to drill a hole which is indexed at 45°, 90° , or 135° the appropriate radial locating arm is attached to the cross-member bar 6 and the workpiece 1 is unclamped and rotated until the pin 3 is inserted through the radial locating arm into a previously drilled hole. The workpiece is then re-clamped, the pin is removed and additional holes can be drilled via the drill bushings 14 disposed in the v-blocks 11 and 21.

FIG. 2 shows that a rectangular or square workpiece 1 can be placed squarely in the v-blocks 11 and 21 by abutting the end surface 75 of the L-shaped locating bar 7 against the rectangular workpiece 1. The screw holders 18 and 28 are tightened against the workpiece 1 and the rectangular workpiece is squarely and securely positioned with respect to the v-blocks 21 and 22.

FIG. 4 shows that holes can be drilled in a longer workpiece 1 by separating the second v-block 21 from the cross-member bar 6. The second v-block 21 is then free to be positioned at any location on the workpiece 1. When the drilling fixture is used in this manner the fixture is placed on a flat worktable by resting on the L-shaped clamping arms 16 and 26 of the respective v-blocks 11 and 21.

FIG. 6 shows the use of the conical locator 76 for drilling a hole that is co-axial with the longitudinal axis of the workpiece 1. The conical locating drill bushing 76 is placed in the hole 71 of the L-shaped locating bar 7. The end of the workpiece is pushed against the conical locating drill bushing 76, which in turn positions the locating bar 7 in the groove 31 so that the conical locator 76 seats itself on the workpiece 1. The conical locating drill bushing 76 is removed and the appropriate size drill bushing 14 is inserted into the hole 71 of the L-shaped locating bar 7 and a hole is drilled in the end face of the workpiece 1.

I claim:

1. A fixturing device for holding a workpiece having a longitudinal axis, said device comprising:
a first v-block having holding surfaces intersecting each other at an intersection and forming a v-shape, said first v-block having a hole formed therein with a center axis being substantially perpendicular to the longitudinal axis of the workpiece and intersecting said intersection of said holding surfaces;
a clamping arm mounted to said first v-block for clamping the workpiece in said first v-block;
a second v-block having holding surfaces intersecting each other at an intersection and forming a v-shape, said second v-block having a hole formed therein with a center axis being substantially perpendicular to the longitudinal axis of the workpiece and intersecting said intersection of said holding surfaces of said second v-block;
a clamping arm mounted to said second v-block for clamping the workpiece to said second v-block;
a cross-member adjustably attaching said first v-block to said second v-block; and
at least one drill bushing removably disposed in one of said hole in said first v-block and said hole in said second v-block.

2. The fixturing device according to claim 1, further comprising:
a locating arm mounted to said first v-block for positioning the workpiece in the direction of its longitudinal axis; and
a channel formed in said first v-block for accommodating said locating arm.

3. The fixturing device according to claim 2, wherein said first and second v-blocks each have a respective groove formed therein for accommodating said cross-member, said grooves being substantially parallel to the longitudinal axis of the workpiece.

4. The fixturing device according to claim 3, wherein said locating arm is L-shaped, has a hole formed therein for receiving one of said at least one drill bushings, and a slot formed in said locating arm for adjusting a position of said locating arm in said channel.

5. The fixturing device according to claim 4, further comprising a tube removably disposed in said hole of said locating arm and a stop bar adjustably mounted to said tube for positioning the workpiece in a direction along the longitudinal axis of the workpiece.

6. The fixturing device according to claim 5, further comprising:
a 90° radial locating arm having a hole formed therein, said 90° radial locating arm being removably and adjustably mounted to one of said cross member, said first v-block, and said second v-block;
one of said at least one drill bushing removably disposed in said hole of said 90° radial locating arm; and
a locating pin being insertable into said one of said at least one drill bushings and into a hole formed in the workpiece for radially locating the workpiece.

7. The fixturing device according to claim 6, further comprising:
a 45° radial locating arm having a hole formed therein, said 45° radial locating arm being removably and adjustably mounted to one of said cross member, said first v-block, and said second v-block;
one of said at least one drill bushings removably disposed in said hole of said 45° radial locating arm; and
said locating pin being insertable into said one of said at least one drill bushings and into a hole in the workpiece for radially locating the workpiece.

8. The fixturing device according to claim 7, wherein said tube includes graduations for positioning said stop bar and said cross member includes graduations for positioning said second v-block with respect to said first v-block.

9. The fixturing device according to claim 7, further comprising:
a further drill bushing having a chamfer;
a chamfer formed in said hole of said L-shaped bracket aligning with said chamfer of said drill bushing when said further drill bushing is inserted into said L-shaped bracket, said chamfers co-axially aligning said hole of said L-shaped bracket with the workpiece.

10. The fixturing device according to claim 9, wherein one of said at least one drill bushings is insertable into said hole in said L-shaped bracket for drilling a hole along the longitudinal axis of the workpiece.

11. The fixturing device according to claim 4, further comprising:
a further drill bushing having a chamfer;
a chamfer formed on said hole of said L-shaped bracket aligning with said chamfer of said drill bushing when said further drill bushing is inserted into said L-shaped bracket, said chamfers co-axially aligning said hole of said L-shaped bracket with the workpiece.

12. The fixturing device according to claim 11, wherein one of said at least one drill bushings is insertable into said hole in said L-shaped bracket for drilling a hole along said longitudinal axis of said workpiece.

13. A fixturing device for holding a workpiece having a longitudinal axis, said device comprising:
a v-block having holding surfaces intersecting each other at an intersection and forming a v-shape, said v-block having a hole formed therein with a center axis being substantially perpendicular to the longitudinal axis of the workpiece and intersecting said intersection of said holding surfaces;
a clamping arm mounted to said first v-block for clamping the workpiece in said v-block; and
at least one drill bushing removably disposed in said hole of said v-block.

14. The fixturing device according to claim 13, further comprising:
a channel formed in said v-block; and
a locating arm for positioning the workpiece along a direction of its longitudinal axis mounted in said channel, said locating arm being L-shaped, having a hole formed therein, and a slot formed therein for adjusting a position of said locating arm in said channel.

15. The fixturing device according to claim 14, further comprising a tube removably disposed in said hole of said locating arm and a stop bar adjustably mounted to said tube for positioning the workpiece in a direction along the longitudinal axis of the workpiece.

16. The fixturing device according to claim 15, further comprising:
a 90° radial locating arm having a hole formed therein, said 90° radial locating arm being removably and adjustably mounted to said v-block;
one of said at least one drill bushings removably disposed in said hole of said 90° radial locating arm; and
a locating pin being insertable into one of said at least one drill bushings and into a hole in the workpiece for radially locating the workpiece.

17. The fixturing device according to claim 16, further comprising:
a 45° radial locating arm having a hole formed therein, said 45° radial locating arm being removably and adjustable mounted said v-block.
one of said at least one drill bushings removably disposed in said hole of said 45° radial locating arm; and
said locating pin being insertable into said at least one drill bushing and into a hole in the workpiece for radially locating the workpiece.

18. The fixturing device according to claim 14, further comprising:
a further drill bushing having a chamfer;
a chamfer formed on said hole of said L-shaped bracket aligning with said chamfer of said drill bushing when said further drill bushing is inserted into said L-shaped bracket, said chamfers co-axially aligning said hole of said L-shaped bracket with the workpiece.

19. The fixturing device according to claim 18, wherein one of said at least one drill bushings is insertable into said hole in said L-shaped bracket for drilling a hole along said longitudinal axis of said workpiece.

20. A fixturing device for holding a workpiece having a longitudinal axis, said device comprising:
a first v-block having holding surfaces intersecting each other at an intersection and forming a v-shape, said first v-block having a hole formed therein with a center axis being substantially perpendicular to the longitudinal axis of the workpiece and intersecting said intersection of said holding surfaces;
a clamping arm mounted to said first v-block for clamping the workpiece in said first v-block;
a second v-block having holding surfaces intersecting each other at an intersection and forming a v-shape, said second v-block having a hole formed therein with a center axis being substantially perpendicular to the longitudinal axis of the workpiece and intersecting said intersection of said holding surfaces of said second v-block;
a clamping arm mounted to said second v-block for clamping the workpiece to said second v-block; and
at least one drill bushing removably disposed in one of said first v-block and said second v-block.
